(19) United States
(12) Patent Application Publication
(10) Pub. No.: US 2022/0058761 A1
(43) Pub. Date: Feb. 24, 2022

(54) METHOD OF RETURNING A MOVING OBJECT FOR A FLEET SYSTEM AND AN APPARATUS FOR THE SAME

(71) Applicants: HYUNDAI MOTOR COMPANY, Seoul (KR); KIA CORPORATION, Seoul (KR)

(72) Inventors: Jae Jun Ha, Hwaseong-si (KR); Young Jun Moon, Sejong-si (KR)

(73) Assignees: HYUNDAI MOTOR COMPANY, Seoul (KR); KIA CORPORATION, Seoul (KR)

(21) Appl. No.: 17/408,134

(22) Filed: Aug. 20, 2021

(30) Foreign Application Priority Data
Aug. 24, 2020 (KR) 10-2020-0106495
Jun. 2, 2021 (KR) 10-2021-0071562

(51) Int. Cl. G06Q 50/30; G06Q 30/02; G06Q 30/00; G06Q 10/06; G08G 1/01

(52) U.S. Cl. CPC G06Q 50/30; G06Q 30/0201; G08G 1/01; G06Q 10/06313; G06Q 30/016

(57) ABSTRACT

A moving object return processing method for a fleet system includes: determining whether a return event has occurred; determining return information of a moving object in consideration of moving object information, user information and vehicle state information, wherein the return information of the moving object includes information on a return zone of the moving object; providing the return information to a user; and performing return processing of the moving object based on the return information of the moving object.

### CROSS REFERENCE TO RELATED APPLICATION

The present application claims priority to Korean patent application Nos. 10-2020-0106495, filed Aug. 24, 2020 and 10-2021-0071562, filed Jun. 2, 2021, the entire contents of which are incorporated herein for all purposes by this reference.

### TECHNICAL FIELD

The present disclosure relates to a fleet system, and, more particularly, to a method and an apparatus for returning a shared moving object using a fleet system.

### BACKGROUND ART

As technology advances, the concept of vehicle ownership is declining and use of shared vehicles has increased. Specifically, vehicles are shared in a specific area or residence for convenience of life and the needs to receive services using them are increasing. For smooth use of shared moving objects in an area where a large number of users are densely populated, a large number of shared moving objects may be stored and managed in the vicinity of the densely populated area.

In a conventional shared moving object service, a small number of shared moving objects are distributed and managed at many points. The conventional service guides and assigns only a shared moving object and a parking zone to a user or sets a predetermined parking zone as a return zone. If only an available moving object is assigned in a parking zone without assigning a shared moving object in a detailed zone within the parking zone, a user who uses a moving object may be assigned a moving object at a long distance from a current or scheduled position thereof.

In addition, when returning a moving object, a parking zone is limited. When returned moving objects are concentrated in a specific area, a user may not return the moving object in a desired area and may return the moving object at a position far from a destination.

### SUMMARY

### Technical Problem

There is no method of assigning the same type of moving objects in several sub-zones according to usage history and usage evaluation of users or group users who frequently use moving objects in a specific parking zone or setting a return zone in consideration of user convenience. The present disclosure provides a method of returning a moving object for a fleet system in consideration of the above-described points.

The present disclosure may provide a method and an apparatus for efficiently returning a shared moving object in a fleet system according to a user's use intention.

The technical problems solved by the present disclosure are not limited to the above technical problems. Other technical problems, which are not described herein should be clearly understood by a person (hereinafter referred to as an ordinary technician) having ordinary skill in the technical field, to which the present disclosure belongs, from the following description.

### Technical Solution

According to an aspect of the present disclosure, a moving object return processing method for a fleet system is provided. The method includes determining whether a return event has occurred and determining return information of a moving object in consideration of moving object information, user information, and vehicle state information. The return information of the moving object includes information on a return zone of the moving object. The method also includes providing the return information to a user and performing return processing of the moving object based on the return information of the moving object.

According to another aspect of the present disclosure, a fleet service management server may be provided. The server includes a transceiver configured to transmit and receive a signal and a processor configured to control the transceiver. The processor may check occurrence of a return event from a user terminal or a moving object. The processor may also determine return information of a moving object in consideration of moving object information, user information, and vehicle state information. The return information of the moving object may include information on a return zone of the moving object. The server may provide the return information to a user.

According to another aspect of the present disclosure, a moving object for providing a fleet service may be provided. The moving object may include a transceiver configured to transmit and receive a signal and a processor configured to control the transceiver. The processor may generate return request information based on a return event and transmit the return request information to a fleet service management server included in the fleet system. The processor may also receive return information of the moving object from the fleet service management server. The return information of the moving object may include information on a return zone of the moving object. In addition, the moving object may provide the return information of the moving object to a user and perform return processing of the moving object.

The features briefly summarized above with respect to the present disclosure are merely some aspects of the detailed description below of the present disclosure and do not limit the scope of the present disclosure.

### Effects of Disclosure

According to the present disclosure, it is possible to provide a method and an apparatus for efficiently returning a shared moving object using a fleet system according to a user's use intention.

It should be appreciated by persons having ordinary skill in the art that the effects that can be achieved through the present disclosure are not limited to what has been particularly described hereinabove or hereinafter and other advantages of the present disclosure should be more clearly understood from the detailed description.

### DESCRIPTION OF DRAWINGS

FIG. 1 is a view illustrating a moving object performing communication with another apparatus through a network.

FIG. 2 is a view illustrating sharing a moving object based on a fleet system.

FIG. 3 is a view illustrating managing a user based on a fleet system.

FIG. 4 is a view illustrating an example of applying an identification device to a moving object.

FIG. 5 is a view illustrating an example of a fleet spot according to an embodiment of the present disclosure.

FIG. 6 is a flowchart illustrating moving object assignment operation of a fleet system, to which a return processing system according to an embodiment of the present disclosure applies.

FIG. 7 is a view illustrating operation of a return processing system according to an embodiment of the present disclosure.

FIG. 8 is a view illustrating operation in which a management server of FIG. 7 determines return information.

FIG. 9 is a view illustrating operation in which a return processing system according to an embodiment of the present disclosure checks factors necessary to determine return information.

FIGS. 10A and 10B are flowcharts illustrating a detailed procedure in which the management server of FIG. 7 determines return information.

FIG. 11 is a flowchart illustrating a detailed procedure in which a management server of FIG. 10b determines return information based on user information.

FIG. 12 is a view illustrating user information managed by a management server provided in a fleet system according to an embodiment of the present disclosure.

FIG. 13 is a view illustrating another example of operation in which a management server provided in a fleet system according to an embodiment of the present disclosure determines return information.

FIG. 14 is a view illustrating the configuration of an apparatus according to an embodiment of the present disclosure.

### DETAILED DESCRIPTION OF THE DISCLOSURE

Hereinafter, embodiments of the present disclosure are described in detail with reference to the accompanying drawings so that those having ordinary skill in the art may easily implement the present disclosure. However, the present disclosure may be implemented in various different ways and is not limited to the embodiments described therein.

In describing embodiments of the present disclosure, well-known functions or constructions are not described in detail since they may unnecessarily obscure the understanding of the present disclosure. The same or equivalent constituent elements in the drawings are denoted by the same reference numerals and a repeated description of the same elements has been omitted.

In the present disclosure, when an element is simply referred to as being “connected to,” “coupled to,” or “linked to” another element, this may mean that an element is “directly connected to,” “directly coupled to,” or “directly linked to” another element. This may also mean that an element is connected to, coupled to, or linked to another element with yet another element intervening therebetween. In addition, when an element “includes” or “has” another element, this means that one element may further include another element without excluding another component unless specifically stated otherwise.

In the present disclosure, e terms first, second, etc. are only used to distinguish one element from another and do not limit the order or the degree of importance between the elements unless specifically mentioned. Accordingly, a first element in an embodiment could be termed as a second element in another embodiment, and, similarly, a second element in an embodiment could be termed as a first element in another embodiment, without departing from the scope of the present disclosure.

In the present disclosure, elements that are distinguished from each other are for clearly describing each feature and do not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become apparent with reference to embodiments described below in detail in conjunction with the accompanying drawings. Embodiments, however, may be embodied in many different forms and should not be constructed as being limited to the example embodiments set forth herein. Rather, these embodiments are provided so that this disclosure is complete and fully conveys the scope of the present disclosure to those having ordinary skill in the art. When a component, device, element, or the like of the present disclosure is described as having a purpose or performing an operation, function, or the like, the component, device, or element should be considered herein as being “configured to” meet that purpose or to perform that operation or function.

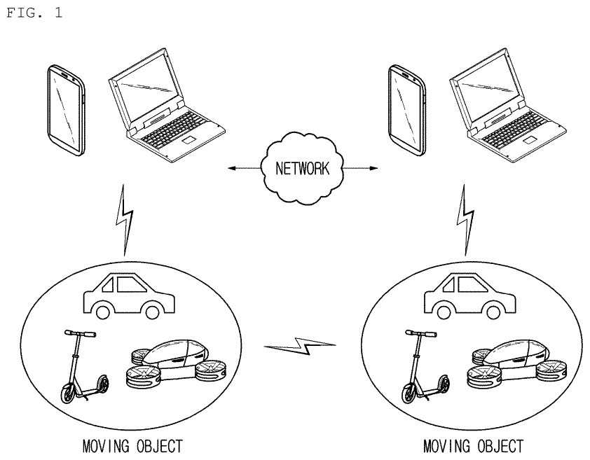

FIG. 1 is a view illustrating a moving object performing communication with another apparatus through a network.

Referring to FIG. 1, the moving object may perform communication with another moving object or another device. For example, the moving object may perform communication with another moving object, or another device based on cellular communication, WAVE communication, dedicated short range communication (DSRC) or the other communication method. In other words, as the cellular communication network, a communication network such as LTE or 5G, a Wi-Fi communication network, a WAVE communication network, etc. may be used. In addition, a short-range communication network used in a moving object, such as DSRC, may be used, but the present disclosure is not limited to the above-described embodiments.

In addition, for example, in relation to communication of the moving object, for security of the moving object, a module capable of performing communication with a device located inside the moving object and a module capable of performing communication with a device located outside the moving object may be separately provided. For example, in moving object, communication with only a device in a predetermined range in the moving object, such as Wi-Fi communication, may be performed based on security. For example, the moving object and the personal user terminal of the driver of the moving object may include communication modules for performing communication between each other. In other words, the moving object and the personal user terminal of the driver of the moving object may use a communication network blocked from an external communication network. In addition, for example, the moving object may include a communication module for performing communication with an external device. In addition, for example, the above-described modules may be implemented as one module. In other words, based on one module, the moving object may perform communication with another device, but the present disclosure is not limited to the above-described embodiments. In other words, in the moving object, a communication method may be implemented based on various methods, but the present disclosure is not limited to the above-described embodiments.

In this case, the moving object may refer to a movable device, for example. For example, the moving object may include a vehicle (including an autonomous vehicle or an automated vehicle), a drone, personal mobility vehicle or device (i.e., hereinafter a “personal mobility”), a mobile office, a mobile hotel or a personal air vehicle (PAV). The personal mobility may include, for example, a moving object including at least three wheels for stable independent traveling or a moving object which has one or two wheels but can be driven independently while maintaining balance (e.g., a single-wheel Segway, a two-wheel Segway, an electric kickboard, etc.). The personal mobility may use electricity using a battery as a power source but is not limited thereto and may use any type of power source capable of moving the mobility. For example, the personal mobility may mean a means of transportation in which only one user rides or a means used by only one user. In addition, the personal mobility may mean a small means of transportation, which may be used by a small number of users. For example, the personal mobility may include not only a single-wheel Segway, a two-wheel Segway and an electric kickboard but also an electric wheelchair, an electric bicycle and an electric two-wheeled vehicle. In addition, the moving object may include the other moving devices and is not limited to the above-described embodiments.

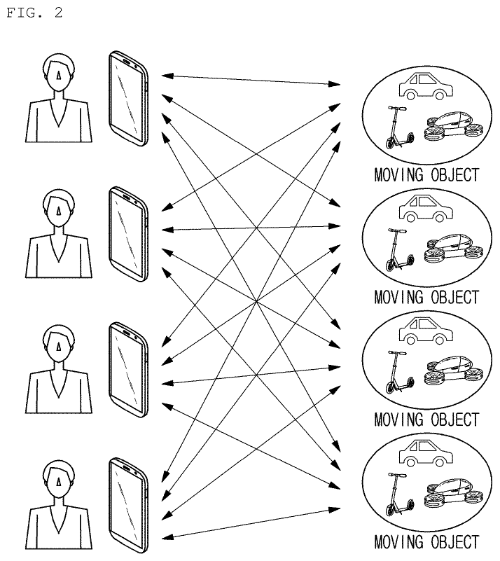

FIG. 2 is a view illustrating sharing a moving object based on a fleet system.

For example, a fleet system may be applied to provide a moving object sharing service. The fleet system may be operated by data generation, processing and exchanging between computing devices. The fleet system may include, for example, at least one server, a plurality of user devices, and a plurality of moving objects. The server may process a request of a user terminal, transmit a response message, process reservation, assignment/return of a moving object according to the request, and manage the moving object, for a moving object sharing (or a fleet service). In addition, the server may receive moving object state information from the moving object, generate overall state information of the moving object, and perform overall management of information related to the moving object.

In addition, the fleet system may include a plurality of user terminals (or devices) and a plurality of moving objects. In addition, for example, the fleet system may further include a road side unit (RSU), etc. The user terminal may include a smartphone, a smart pad, a smart watch, etc. As another example, the user terminal may mean a device capable of exchanging signals through the other communication but is not limited to the above-described embodiment. However, hereinafter, for convenience of description, this is referred to as a device or a user terminal. In addition, for example, the moving object may be a vehicle. In addition, for example, the moving object may be an object moving in a provided area such as a rail. As another example, the moving object may be a flying object such as a drone. In other words, the moving object may refer to a movable object and may mean a moving object shared based on the fleet system. However, although the vehicle is described below for convenience of description, this is equally applicable to the other moving objects. As another example, the RSU is a road side unit and may be a device capable of performing communication. In addition, for example, the RSU may refer to a structure installed to transmit and receive signals to a building or the other area and is not limited to the above-described embodiment. However, hereinafter, this is collectively referred to as the RSU for convenience of description, may be various structures or devices, and is not limited to the above-described embodiment.

In addition, the fleet system may be a moving object sharing system. The fleet system may be a system in which a moving object is shared in a predetermined area. The predetermined area may have the local concept such as apartment complex or a work area. For example, the predetermined area may be an area in an apartment complex or may be an area separated from the apartment complex by a preset distance. As another example, the predetermined area may mean an area separated from a work area by a preset distance. As another example, an area to which the fleet system applies may be a larger area or a city unit, such as an administrative district, and is not limited to the above-described embodiment. In other words, the predetermined area may mean a reference range in which operation based on the fleet system is possible and may be changed by a user or a system. In addition, for example, the fleet system may be a system in which the moving object is shared by users authenticated as specific users (or devices). For example, the specific user may be a resident of an apartment in a predetermined range in which the service of the fleet system may be provided or a worker of an office located in a specific area. For example, the specific user may be a person subscribing to the fleet system providable in a predetermined service area and may be a user outside the service area. Such a user may try to approach a certain service area to use a sharing service. For example, the fleet system may provide the moving object sharing service based on a device registered by the resident of the apartment or the worker of the office. Therefore, it is possible to provide the sharing service to only the specific target and to increase moving object security and management efficiency. However, the specific user who uses the shared moving object in the fleet system may be determined based on the other method and is not limited to the above-described embodiment. The shared moving object fleet system may be provided with a shared moving object. The shared moving object may be a moving object authorized or authenticated to be shared by the system. For example, the shared moving object may be a moving object registered in the fleet system. A fleet system administrator may provide the shared moving object for the fleet system. In other words, only the moving object authorized or authenticated by the fleet system administrator may be used as the shared moving object. Therefore, it is possible to prevent accidents, which may occur due to security or management of the shared moving object in the fleet system. More specifically, the moving object to be shared may be registered in the fleet system. The right to register the shared moving object in the fleet system may be restricted by the fleet system. The moving object, which may be registered in the fleet system, may have the same ID or the same identification information. In addition, since the fleet system provides the shared moving object, the shared moving object may be managed. For example, management of the shared moving object may be information necessary to provide a shared moving object service, such as residual oil information of the moving object registered in the fleet system, moving object status information, or moving object operation information. The fleet system may check the status of the shared moving object in real time, control authority for use, or transmit a command for maintenance through the system with respect to a moving object in which a problem has occurred and provide a service based on this.

As another example, the fleet system may provide a mixture of a shared moving object and a private moving object. For example, the fleet system may set identification information for identifying the shared moving object provided by the system and the private moving object, for example, a moving object type indication field. When a value other than the private moving object is recorded in the indication field, the shared moving object may be indicated as a moving object provided by a system provider without private possession. On the other hand, when a value indicating the private moving object is recorded in the indication field, this may indicate that the moving object is privately possessed and the moving object is provided to the fleet system as the shared moving object. The case where the private moving object and the shared moving object provided by the system are mixed may also be considered. For example, the service provided by the fleet system may vary based on the moving object type indication field. For example, in the case of the moving object provided by the fleet system, there may be no restriction on the use of a user who uses the moving object. On the other hand, in the case of the private shared moving object, there may be use restriction. As another example, the fleet system moving object and the private shared moving object may provide services based on different charging systems and is not limited to the above-described embodiment.

As another example, in relation to the detailed operation of the fleet system, a service may be provided based on a device registered in the fleet system.

More specifically, the user terminal registered in the fleet system may obtain information on the shared moving object after an authentication and security procedure with the system. In other words, the user terminal may be provided with the information on the shared moving object. The user terminal may be brought into contact with the moving object to be used based on the information on the shared moving object.

For example, there may be a registered moving object or a registered user terminal (or device) in the fleet system. In other words, only a specific moving object and user terminal may be registered in the fleet system based on authentication and authorization. In this case, the fleet system may be operated based on the status information of the registered moving object and the registered user terminal. For example, the fleet system may check information on a moving object, which is currently being used and position information of an individual moving object in real time. For example, each moving object may periodically transmit information thereof to the fleet system. In addition, for example, each moving object may transmit information thereof to the fleet system based on a triggered event. For example, when an event in which the position of the moving object is changed or whether to use the moving object is changed is triggered, the moving object may transmit information thereof to the fleet system (or the server). In addition, the fleet system (or the server) may check information on the registered user terminal in real time. For example, the registered user terminal may not always use the service of the fleet system. Accordingly, activation information indicating whether the registered user terminal uses the service of the fleet system may be necessary. For example, the fleet system may include information on a list of registered user terminals. A user terminal, which is currently using the moving object or activates the system for use of the moving object among the registered user terminals included in the list of the fleet system, may be provided together with the list information. As another example, a registered user terminal (deactivated user terminal), which does not use the fleet system, a registered user terminal (activated user terminal), which is using the moving object of the fleet system, and a registered user terminal (temporary user terminal), which wants to use the moving object, may be distinguishably displayed. In other words, information on whether the moving object is actually being used, whether there is no intention of using the moving object, or whether there is an intention of using the moving object, but the moving object is not yet used may be provided. In addition, for example, usage state information may be further indicated with respect to the user terminal, which is using the moving object of the fleet system. For example, the usage state information may further include expected use time information or use position information.

More specifically, the fleet system may include list information of a plurality of registered moving objects and a plurality of user terminals. In this case, the list information may include at least one of usage state information, user terminal position information, or moving object position information. In this case, the fleet system may provide a moving object sharing service based on the user terminal position information and the moving object position information. In addition, the usage state information may include at least one of information on a moving object in use, expected time information of a moving object in use, user terminal-moving object matching information, deactivated terminal information, activated terminal information, activated moving object information, or deactivated moving object information. In this case, for example, the usage state information may further include information on a moving object currently used by another user terminal and expected time information of a moving object in use. In addition, the usage state information further includes user terminal-moving object matching information based on information on the form of a list. In addition, the usage state information may include activated terminal information and deactivated terminal information. For example, the activated terminal information may be a user terminal, which is currently using the moving object, or a user terminal, which is preparing for using the moving object among user terminals registered in the fleet system, as described above. For example, the activated user terminal may mean a user terminal, which has executed a program or application for the fleet system. Meanwhile, the deactivated user terminal may be a user terminal which is registered in the fleet system but does not use sharing of the moving object. For example, the deactivated user terminal may be a user terminal, which does not execute or deactivate the program or application for the fleet system.

In addition, the fleet system may include activated moving object information and deactivated moving object information. In this case, for example, the fleet system may include status information of a plurality of moving objects. In this case, the status information of the moving object may be information on whether the moving object is normal or abnormal or information on the moving object such as remaining traveling distance information or refueling time information. In other words, the status information of the moving object may be information for determining whether the moving object may be provided for sharing of the moving object and is not limited to the above-described embodiment. In this case, the fleet system may determine whether the moving object is activated based on the status information. For example, the fleet system may classify a moving object, which is in a normal state and has a sufficient amount of oil as an activated moving object and provide information. On the other hand, the fleet system may classify a moving object, which is in an abnormal state as a deactivated moving object. In this case, the fleet system may provide information on the deactivated moving object to an associated system or server. For example, the associated system or server may perform repair or management with respect to the deactivated moving object and is not limited to the above-described embodiment.

In addition, for example, the fleet system may classify a moving object having a predetermined amount of oil or less as a deactivated moving object. As another example, when a moving object having a predetermined amount of oil or less is shared through a user terminal, the fleet system may provide information on the amount of oil to a user of a user terminal through a notification. In addition, for example, the fleet system may provide information on an associated designated system (e.g., a gas station of a particular brand) to a user and provide information indicating that refueling is required. In this case, the fleet system may exchange charging or other necessary information with the associated designated system regardless of the user and provide a service based on this.

In other words, a user who uses a moving object sharing system may refuel at a designated place without paying a fee and handle the fee through a system linked to the fleet system. Meanwhile, for example, as described above, a device (temporary device), which wants to use the moving object, may use the moving object by checking the fleet system.

For example, the user terminal may be assigned a moving object to be used through the fleet system. In this case, for example, the fleet system or the server may assign the moving object to the user terminal using at least one of information on a moving object in use, position information of the moving object, or position information of the user terminal. Meanwhile, for example, the fleet system may provide information on failure to the user terminal when the moving object cannot be assigned. In addition, for example, the fleet system may assign only a moving object within a certain distance based on the position of the user terminal and is not limited to the above-described embodiment. Next, the user terminal may approach the moving object within a certain distance. In this case, the user terminal may transmit an authentication signal to the moving object. In addition, for example, the user terminal may use the shared moving object through a tag on the shared moving object based on a list of available moving objects. For example, the user terminal may perform tagging with respect to the moving object based on magnetics such as NFC, Bluetooth or transportation card. In this case, when the user terminal is tagged, the shared moving object may perform an authentication procedure from the fleet system such that the user terminal provides the moving object. For example, when authentication is completed based on the user terminal tag, the door of the moving object may be opened.

In relation to detailed authentication operation, when the user terminal approaches the moving object within a certain distance, an authentication signal may be transmitted to the moving object. In this case, communication, which may be used by the moving object and the user terminal, may be Bluetooth, NFC or a tag as described above. In other words, an authentication procedure may be performed under a certain condition and is not limited to the above-described embodiment. When the user terminal approaches the moving object or performs tagging, the moving object and the user terminal may determine whether the user terminal can use the moving object through signal exchange and perform authentication. In this case, the user terminal may transmit an authentication signal including identification information thereof and identification information of a group, to which the user terminal belongs, to the moving object. In this case, the moving object may determine whether the user terminal is registered in the fleet system based on the identification information of the user terminal included in the received authentication signal. In addition, the moving object may determine whether the user terminal is included in a group, to which a service is capable of being provided by the moving object, based on the identification information of the group included in the authentication signal. In other words, the moving object may determine whether the user terminal may use the moving object based on terminal identification information and group identification information. For example, when the user terminal may not use the moving object, the moving object may transmit information indicating that the user terminal is unavailable. For example, the user terminal may obtain information indicating unavailability from an application or other service provision program.

Meanwhile, when the user terminal may use the moving object, the moving object may transmit a signal for a request to perform an authentication procedure to the user terminal. In other words, when the user terminal is legally registered in the fleet system (or the server) and the moving object may also legally operate based on the fleet system, the moving object may transmit the signal for the request to perform the authentication procedure to the user terminal. In this case, the moving object may transmit the signal for the request to perform an authentication procedure, including identification information thereof and encryption key information, to the user terminal. For example, both the identification information of the moving object and the user terminal information may be registered in the fleet system. In this case, the moving object may transmit a signal including the identification information of the moving object, the identification information of the user terminal, and the encryption key information to the fleet system.

In addition, the device may also transmit, to the fleet system, a signal including the identification information of the moving object, the encryption key information, and the identification information thereof included in the signal for the request to perform the authentication procedure.

Thereafter, the fleet system may compare the signal received from the moving object and information included in the signal received from the user terminal. In this case, when all the identification information of the moving object, the identification information of the user terminal and the encryption key information are the same, the fleet system may recognize that the user terminal may use the moving object. Thereafter, the fleet system may transmit an authentication confirmation information to the moving object and the user terminal. In this case, the fleet system may register information indicating that the user terminal uses the moving object in a database. In addition, for example, a time when the user terminal uses the moving object and additional information may also be continuously transmitted.

In addition, the moving object may register the user terminal based on the authentication confirmation information and the door of the moving object may be opened. In addition, a lock for using the moving object may be unlocked to allow the user terminal to control the moving object.

In this case, for example, when the above-described authentication is completed, the moving object and the user terminal may periodically exchange signals. In other words, while the user terminal uses the moving object, the moving object may continuously confirm use through periodic signal exchange with the device.

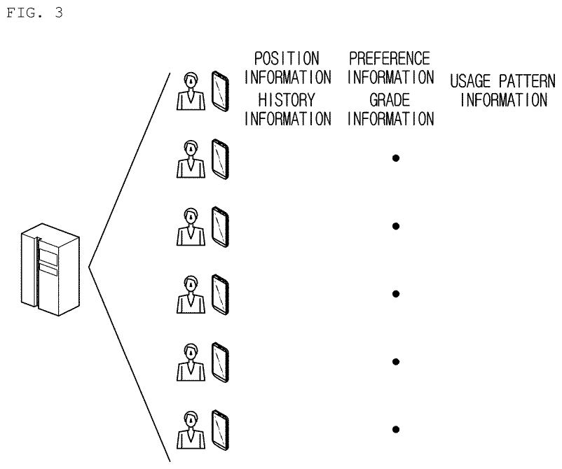

FIG. 3 is a view illustrating managing a user based on a fleet system.

For example, based on the above description, the moving object and the user terminal may be managed in the fleet system. In this case, for example, in the fleet system, information on each user may be managed. For example, information on each user may be information on user usage based on a user ID or a user identification device. As a more specific example, information on each user may include at least one of user position information, user history information, preference information, usage status information, grade information, or usage pattern information.

For example, the user position information may be information for checking a mainly used path of a user who uses the fleet system. For example, the user position information may be static position information set by a user, such as user's residence and workplace and dynamic position information such as position information at the time of request for use and position information at the time of use. In addition, for example, the fleet system may store user history information.

The history information may be user tendency information analyzed based on the type of the moving object used by the user, an area of use of a fleet spot provided to the fleet system, a moving route, a destination point, a parking point during use. For example, the fleet system perform recommendation for use of the moving object based on the user history information. In addition, for example, the fleet system may perform management for moving object assignment and distribution using the history information of a plurality of users.

In addition, for example, the fleet system may include user preference information. For example, the user preference information may be information considering the frequency or preference of the used moving object. Specifically, the preference information may be the type of the moving object, which is designated or estimated to be preferred by the user. In addition, for example, the user preference information may be input by a user and is not limited to the above-described embodiment.

In addition, for example, the fleet system may provide the grade information of the user. The grade information may be given to each user based on use situation information including subscription information of the fleet system and usage result information and evaluation information after using the moving object. For example, the subscription information may be related to whether a user makes a long-term contract or subscribes to a premium membership as a contract condition for the service of the fleet system. The usage result information may include a frequency of using the moving object and use cost according to a time or distance, etc. When the user frequently uses the moving object, the grade level may increase. In addition, in the evaluation information, when the subsequent user or an administrator determines inappropriate use due to user's smoking or behavior causing a bad smell or when such a determination is accumulated, the grade level of the user may decrease. In addition, in the evaluation information, when the moving object is used without an accident or is continuously used well so that unnecessary maintenance does not occur, the grade level may increase. the grade information of the user may be used as a criterion for determining assignment and return information of the moving object.

In addition, the fleet system may provide usage pattern information of the user. The usage pattern information may be generated by collecting at least one of life pattern information or riding pattern information of each user. For example, the life pattern information may be generated based on at least one of consumption information of the user, a destination point when the moving object was used in the past or a stopping point when the moving object was used in the past. The riding pattern information may be configured based on at least one of the use area and parking lot of the moving object, the average number of passengers of the moving object, the age and gender of the passenger, or passenger body information. The fleet system may determine at least one zone suitable for the user in the large-area fleet spot in consideration of the usage pattern information and assign a moving object disposed in the zone. In addition, the fleet system may analyze the usage pattern information and assign a moving object or set return information.

In other words, the fleet system may match the moving object and the user based various information related to the user. In addition, the fleet system may manage the user based on user related information.

The above-described various information may be stored in and managed by a server for controlling the fleet system, for example. As another example, at least some of the information may be stored in an identification device mounted in or tagged on the moving object or a device, which may communicate with the system and the moving object. The identification device may be used to identify and authenticate the user who makes a reservation when the user uses the assigned moving object. The identification device may transmit data for control of the moving object to the moving object and the fleet system (server) in addition to the purpose for authentication. For example, the identification device may store the grade information of the user and apply benefit information and penalty information (hereinafter referred to as benefit and penalty) according to the grade level of the user to control of the moving object. In addition, the identification device may detect user's inappropriate use through a sensor mounted in the moving object, store and transmit evaluation information determined in real time to the server and enable the server to update the evaluation information. In addition, the identification device may collect and transmit life pattern information, such as real-time movement path, a destination point, and a stopping point of the moving object, to the server and enable the server to update the life pattern information or to change a return zone and a parking lot designated at the time of reservation. In addition, the identification device may obtain riding pattern information different from that at the time of reservation, transmit it to the server, and enable the server to update the riding pattern information or to change the return zone and the parking lot designated at the time of reservation.

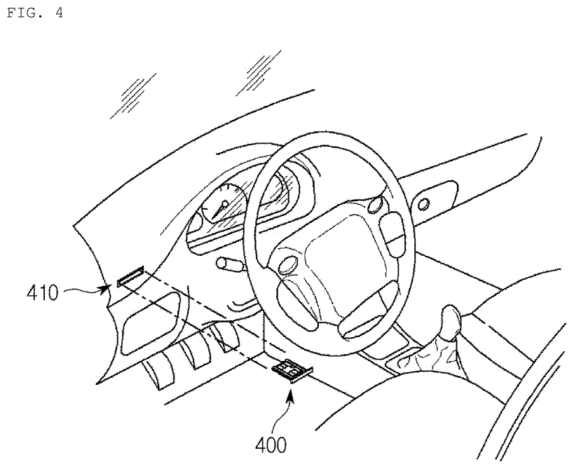

The form of the identification device is shown in FIG. 4. FIG. 4 is a view illustrating an example of applying an identification device to a moving object.

The identification device may have at least one of functions for identifying a user, a control target or a service target. In addition, for example, the identification device may have an ID function. In addition, the identification device may be at least one of a smart device, a smart module, a user identification module, or an identification module. In other words, the identification device may be a hardware component. In addition, the identification device is a software component and may be used for identification. At this time, for example, the identification device may be an SIM (Subscriber Identity Module). For example, the SIM applied to the moving object as the identification device may include at least one of a Mobility SIM (M-SIM) or a Vehicle SIM (V-SIM). In addition, for example, the identification device may be equal to or compatible with the existing SIM and is not limited to the above-described embodiment.

As described above, the identification device may be applied to the moving object in consideration of the case where the moving object performs communication with an external device. For example, a universal subscriber identification module (USIM) may is installed in a user terminal phone, such that a user is recognized through the USIM to provide a service. The moving object may have an identification device card installed therein based on the above description. For example, the identification device applied to the moving object may be referred to as Vehicle SIM (VSIM). In other words, a new type of the identification device is applicable as the identification device applied to the moving object. For example, the VSIM may be compatible with the USIM or another SIM. In addition, the VSIM may further provide another service in consideration of the characteristics of the moving object and is not limited to the above-described embodiment.

As shown in FIG. 4, there may be a part to which the identification device 400 is applied, in the moving object. At this time, FIG. 4 shows one example of applying the identification device and is not limited to the above-described embodiment. More specifically, as shown in FIG. 4, there may be a part 410 to which the identification device 400 is applied, in a visually identified part of the driver's seat of the moving object. Although not shown, as another example, the identification device may be applied to the glove box located at the passenger's seat of the moving object. As another example, the identification device may be inserted into a part in which the display of the moving object is present, but this is not limited to the above-described embodiment. There may be a slot in which the identification device may be accommodated, at an appropriate part inside or outside the moving object. As another example, in consideration of portability of the identification device, the identification device may be implemented in combination with a tool key or a car key. In other words, the identification device may be mounted in the tool key or the car key, the identification device detached from the car key may be mounted in the moving object to be used. The tool key or the car key may perform communication with the moving object through short-range communication (e.g., Bluetooth, beacon or NFC). Therefore, message exchange may be performed and identification may be performed. In other words, the car key or tool key reflecting uniqueness of an individual may be used as the identification device and is not limited to the above-described embodiment.

As another example, the above-described identification device may be mounted through an existing device mounted in the moving object. For example, the existing device (e.g. a road payment terminal or black box) may be already installed in the moving object. As another example, the identification device may be recognized through an existing terminal (e.g., a USB port or a cigarette jack) included in the moving object.

As another example, the identification device is applicable to any position in a range in which authentication is possible in the moving object, and the identification device may be integrally or detachably applicable to a control unit, communication unit, or part of the moving object.

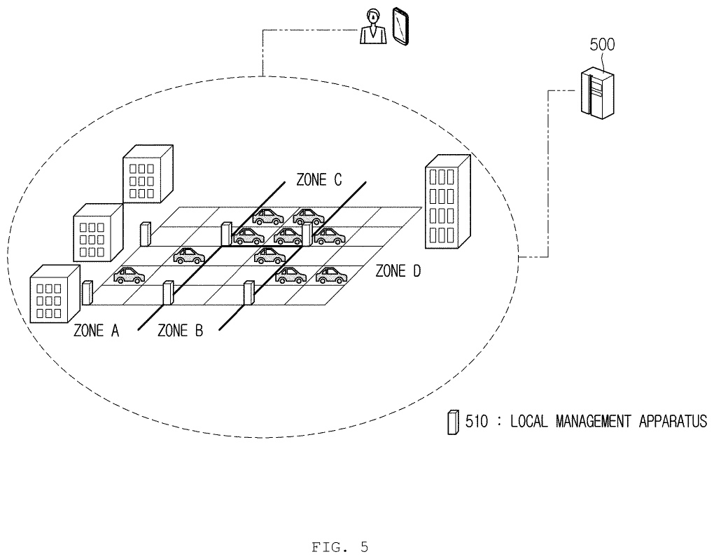

FIG. 5 is a view illustrating an example of a fleet spot according to an embodiment of the present disclosure.

The fleet system may be operated with a fleet spot which is a space where a shared moving object is capable of being assigned or returned. The fleet spot may be an area where the shared moving object is stored in a predetermined area to provide a service. For example, the predetermined area may be located near an area where residential districts and/or commercial districts are concentrated. This is to increase convenience of the service provided by the fleet system to people who use buildings near the residual and/or commercial buildings accommodating a large number of people or with a large floating population. People who may use the fleet system may include not only people who reside in the buildings but also people who use the fleet system for a variety of purpose, such as people who visit an area around the fleet spot or transfer to another moving object through the fleet spot.

The fleet system according to the present embodiment may be operated with a small number of moving objects or a large number of moving objects for service expansion and convenience through the fleet system. When being operated with a large number of moving objects, the fleet spot may have a large area in order to accommodate various kinds of moving objects. When the fleet spot is operated as a large-area space, a plurality of moving objects may be disposed to be uniformly accommodated in the large space and may be disposed in consideration of the buildings around the fleet spot, the number of resident people or a floating population. Therefore, the fleet spot may be partitioned into a plurality of zones, as shown in FIG. 5, in order to efficiently manage the plurality of moving objects. Each zone may be assigned an accommodation area and a parking lot in consideration of information on the vicinity of the zone, such as the buildings around the fleet spot, the number of resident people, or a floating population. For example, in zone A, which is located near an area where commercial buildings are concentrated, the type of the moving object may include medium or small sedan-style vehicles and vehicles, which can accommodate 7 to 11 people. In Zone A, personal mobility may have a large proportion and large luxury sedan-style vehicles may be assigned at a relatively low rate. The above assignment may be made in consideration of the number of residents of the building, the number of visitors, expected purposes of shared moving objects (e.g., business trips, delivery, private usage, etc.), average use status of shared moving objects (e.g., clean usage, light maintenance request frequency, long-distance movement, and the average number of passengers). In addition, the medium and small vehicles may be assigned to Zone A such that medium to excellent levels have a relatively larger proportion than a best level in terms of the detailed type of the moving object such as a production year and cleanliness. The large luxury vehicles may be assigned such that excellent to best levels have a relatively large proportion. As another example, in the case of zone D near the residential area, the shared moving objects are mainly used for private purposes such as shopping, commuting, family sharing and personal lifestyles. Cleanliness and a maintenance request frequency may be relatively excellent. Based on this, small and large sedan-style vehicles and vehicles, which can accommodate 7 to 11 people, may be uniformly assigned to zone D. Vehicles with excellent to best levels in terms of the production year and the cleanliness have a relatively large proportion.

As another example, a maintenance or inspection zone may be disposed in the zones of the fleet spot. For example, when there is no reservation for a moving object to be returned for a predetermined time and the fleet system determines that inspection of the moving object is necessary or when the fleet system determines that urgent maintenance is required based on the moving object status information although there is a next reservation, the fleet system may induce the user of the moving object to return the moving object to the maintenance zone instead of the return zone. As another example, when the fleet system determines that maintenance of an unused moving object parked in a non-maintenance zone is required, the fleet system may move the moving object to a pre-designated zone in an unmanned or manned manner. At this time, the pre-designated maintenance zone may be a place where maintenance and management of the moving object are performed, such as a moving object repair shop, a car wash, or a moving object interior cleaning company.

As another example, the fleet system may manage the moving objects by grouping them in a predetermined number of units. In addition, the fleet system may perform maintenance and management of the moving object in group units. In the above-described example, when the maintenance zone is a repair shop or a car wash, a designated area (a repair shop, a car wash, a vehicle interior cleaning company, etc.) for maintenance and management of the moving object for each moving object group may be set. In other words, when maintenance and management of the moving object are required, the fleet system may move the moving object to the designated area for each group in a manned or unmanned manner such that maintenance and management of the moving object are performed. By performing maintenance and management of the moving object for each moving object group, it is possible to perform maintenance and inspection of a larger number of moving object within a limited time.

As another example, in the fleet system, a support unit for maintenance and management of the moving object may be disposed for each moving object group, such that maintenance and inspection of the moving object may be rapidly performed during inspection. For example, the support unit may be a maintenance vehicle disposed for maintenance and management of the moving object.

The fleet system may be, for example, operated such that a central server 500 manages moving object assignment/return state, moving object status information related to a position and usage state, and/or zone rearrangement of the moving object for each zone. The central server 500 also processes a variety of information for each user. As another example, in the fleet system, a local management apparatus 510 in charge of each zone may be disposed to process and manage a task related to the moving object and to receive a user's request for use, such that tasks, until a moving object of a specific zone is assigned, and a variety of information on each user are managed by the central server. For example, the local management apparatus 510 may detect entry or exit of a moving object in the fleet spot and store and manage the result of detection in a database. The server may receive the result of processing the task related to the moving object from the local management apparatus 510 and update information on each user. Hereinafter, although, for convenience of description, the central server 500 processes information on each moving object and user and manages all zones, such processing may be performed in the server and the local management apparatus 510.

In principle, the fleet system is operated such that the moving object is rented in the fleet spot and is returned in the corresponding zone. However, the fleet system may be flexibly operated such that the moving object is returned to a zone other than the corresponding zone according to user grade information or usage pattern information. In addition, the fleet system may allow return to a heterogeneous fleet system in consideration of a premium service type used by a user, a temporary request, and grade information.

Although the zones are arranged adjacent to each other on the ground in FIG. 5, the zones may be spaced apart from each other in a distance range in which users may easily move on foot or using personal mobility operated in a short distance, according to distribution of surrounding buildings and populations. As another example, the zones of the fleet space may be provided on the ground or may be set on each floor of a multi-story building facility or in a plurality of areas defined for each floor in order to increase the usability of the ground.

Hereinafter, a fleet system implemented by a computing apparatus assigning a moving object is described.

The fleet system may include an application or program for assigning a moving object, which is collectively referred to as an application for convenience of description. The application may perform a moving object assignment process based on requests and data transmitted among a user terminal, a shared moving object, and a server. Such an application may be installed in all of the user terminal, the shared moving object, and the server, such that the server obtains information generated from each computing device to perform the process. Hereinafter, although, for convenience of description, the server mainly performs the process, for example, in order to efficiently ensure a storage space of the server memory, data generated in a process of using the moving object may be accumulated and aggregated in the user terminal and/or the moving object and data accumulated up to the time of the request may be transmitted to the server according to the request of the server.

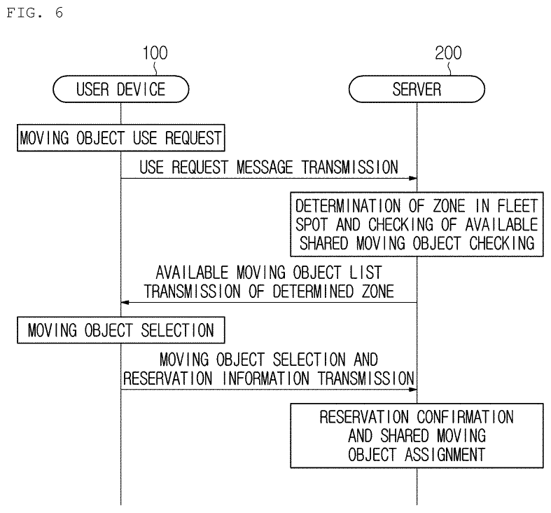

FIG. 6 is a flowchart illustrating a moving object assignment method for a fleet system according to an embodiment of the present disclosure.

First, a user terminal 100 may request use of a moving object from a server 200 of the fleet system. A use request may include at least a moving object use time and a use request transmitted to the server 200 may be a message generated based on the moving object use time. For example, a use request message may be generated by further including user position information along with the moving object use time. The user position information may be, for example, a residence or workplace registered by a user. In addition, the user position information may be position information at the time of requesting use checked through the user terminal or position information input as an expected position when the user uses the moving object. For example, when the position information is set to the residence or workplace basically or later, the position information may be determined. As another example, when position information at the time of use request or position information at the time of scheduled use is separately selected and input instead of the residence or workplace, the position information may be set to the selected position.

The use request may be a message including at least one of a moving object type, history information, preference information, or grade information, in addition to the moving object use time. The moving object type may be the type of the moving object selected by the user device at the time of request and detailed classification. The type may include small to large sedan-style vehicles, sport utility vehicles (SUV), vehicles with 7 to 11 passengers, luggage carriers, personal mobility, etc. The classification may include maker, detailed model, a production year, cleanliness, good maintenance state, etc. of the moving object. The history information, the preference information, the grade information, and the usage pattern information are described above and detailed descriptions thereof have been omitted. The user terminal 100 may preset whether the above-described information is included through the application and program provided by the fleet system. If it is preset, the use request may be a message based on the moving object use time and information set in the user terminal, except for user position information. Even if it is preset, the user terminal requests generation of the use request message including the position information along with the setting information and the use time at the time of additional settings or request. In this case, the use request message may be generated to include all the above-described information or may be generated based on the requested position information requested prior to estimated position information of the user inferred from the setting information.

Next, the fleet system (or the server) 200 may determine at least one zone suitable for the use request and check a list of available moving objects including available moving object of the zone.

When the use request is a message generated as the moving object use time and the user position information, the server may check the moving objects of each zone available at a use time by referring moving object use scheduling and sequentially align the moving objects from a closest zone to a gradually separated zone according to the user position information among zones in which available moving objects are checked. A predetermined number of moving objects may be aligned.

As another example, the use request including the moving object use time may be a message generated as a combination of position information and other information or other information without position information, along with a moving object use time. For example, when the position information is not included and the other information is at least one of history information or preference information, the server 200 may search for a moving object type identified from the history information and/or the preference signal and a moving object suitable for a past/preferred use zone of a fleet spot in use scheduling. The server 200 may select an available moving object corresponding to a type in the searched zone. Here, when there is no moving object corresponding to a preferred type and a use zone at the moving object use time, the server 200 may match a moving object with the same level as the preferred type in a zone close to the preferred use zone. In addition, when the history information further includes at least one of a movement route, destination point, or parking point of the user during use, the server 200 may generate history information by giving a weight to the movement route, the destination point, and the parking point, which frequently occur, rather than one-time occurrence. The server 200 may analyze the user's purpose of using the moving object, for example, long-distance driving, a business trip, or a personal purpose such as shopping or a home visit, using the generated history information. When it is analyzed as a business trip through long-distance driving using the history information, the server may check, for example, available sedan-type moving objects of medium or less, latest models, and lower mileages in all zones. In addition, the server 200 may further consider the moving object type and the use zone. In this case, a zone and a moving object suitable for the type and the use zone may be selected from among the moving objects checked based on the use purpose. Meanwhile, when the use request is generated as a message including the user position information along with the history information and/or the preference information and the server determines a zone, the user position information may be set to take precedence over the use zone of the history information and/or the preference information. Accordingly, the server 200 may select an available moving object, in an order from a zone closest to the position of the user position information to a distant zone, from the moving objects by checking the history information.

As another example, other information of the use request may be grade information. The use request may be a message generated as a combination of the user position information and the grade information or grade information with the position information, together with the moving object use time. The server 200 may check a benefit and a penalty given to a user who has requested use according to the grade level of the grade information and determine an assignment condition of the moving object based on the checked benefit and penalty. For example, the server 200 may determine an available moving object and a zone of the moving object satisfying the assignment condition including the type, specification, production year, cleanliness, and assignment zone of the moving object. As a specific example, although a user has low grade information, which does not consider assignment of an adjacent zone while a high-end sedan is disallowed but requests a high-end new-model sedan as a detailed option of the use request, the server may not consider the detailed option of the user. More specifically, the server 200 may inquire an available moving object from sedans lower than the high-end sedan and determine a moving object of a zone, which is not adjacent to the position information of the user when the use request of the user overlaps that of a user having a higher grade than the user.

As another example, other information of the use request may be usage pattern information. The use request including the moving object use time may be a message generated as a combination of the user position information and the usage pattern information or usage pattern information without the position information.

The usage pattern information may be generated by collecting at least one of life pattern information or riding pattern information for each user, as described above.

The usage pattern information may be set by the user before or at the time of the use request and may be included in the use request message. In addition, the usage pattern information may be estimated based on travel position information of the moving object obtained according to user's content, user's purchase/transaction data for goods and services during the moving object use time, an image acquisition device mounted in the moving object, and riding information recognizable from a communication. The communication is performed between identification devices of the user terminal 100 of all of a driver and passengers and the moving object and may use a communication or signal technology, such as ultra wide band (UWB), beacon, Bluetooth, or Wi-Fi. For example, the travel position information may include a stopping place, a destination, and a parking/stopping place of the user through the moving object and include a shopping mall, a hospital, or a specific building for a business trip visited by the user. The purchase/transaction data may be a list of goods and services purchased and consumed by the user at the moving object use time. The goods may be purchased at a shopping mall, market, outlet, clothing store, etc. and the services may be cultural services such as hospital diagnosis, movie, or concert.

The life pattern information may be determined based on the list of goods/services purchased/consumed with high frequency during a recent moving object use time. For example, when payment information frequently occurs recently in a university hospital, an orthopedic clinic or a hospital related to a special disease, the life pattern information may be set by applying a weight to a hospital service compared to the other items by referring to the recent payment information. In addition, the usage pattern information of a specific user may be determined by considering travel position information checked by hospitals, which have been recently and frequently visited, and riding information of an elderly person who has ridden to visit the hospital during the moving object use time. Of course, since the travel position information and the purchase/transaction data and the riding information are changed over time, a higher weight is applied to the above-described information obtained using the recent use time of the user than a weight applied to previous information, ranking information on a plurality of positions, purchased items and passengers included in the usage pattern information.

When the use request is a message including the life pattern information, the server 200 may determine the assignment condition of the moving object according to the life pattern information of the user who has requested use. For example, the server 200 may determine that the user has purchased a large amount of goods and consumed a lot of money in a specific shopping mall as a result of inquiring the recent stopping place, destination, and purchase/transaction data of the user. If the shopping mall is included as the planned travel position, the server 200 may determine an available moving object and the zone of the moving object satisfying the assignment condition suitable for the life pattern information, for example, the type, specification, production year, and cleanliness of the moving object. In the above-described example, when the life pattern information of the user who has requested use includes the purchase of a large amount of goods in the shopping mall, the server may select an available moving object of an SUV type capable of loading a large amount of goods and having a model of 3 to 4 years ago and a cleanliness condition of medium or higher. Considering that, in the fleet system, moving objects are arranged such that assignment and return zones are as the same as possible, the server 200 may present the selected moving object from a zone as close as possible to the user's residence. Therefore, the user may return the moving object to the return zone close to the user's residence, such that the user may carry the large amount of purchased goods to their residence in a short distance.

As another example, as a result of inquiring the usage pattern information of the user who has requested use, when a middle-aged driver has periodically visited a specific hospital with an elderly passenger recently and there is hospital service payment information, if the request is made such that the moving object use time substantially matches the hospital vising period, the server 200 may determine an available moving object and the zone of the moving object satisfying the assignment condition corresponding to the usage pattern information. In the above-described example, the server may select an available moving object of a medium or larger sedan type that a plurality of passengers has ride comfort, a latest model, and a superior cleanliness condition or higher. For convenience of use of the elderly passenger, the server may select and present the selected moving object from a zone as close as possible to the user's residence.

Next, the server 200 may receive reservation information based on the moving object selected by the user terminal 100 from the list of available moving objects.

As described above, the list of the available moving objects may be presented by enumerating moving objects in an appropriate zone according to moving object use scheduling in the case of a use request composed of only a use time. As another example, if the use request is a message including at least one of the position information of the user, the type of the moving object, the history information, the preference information, the grade information, the life pattern information of the user, or the riding pattern information of the moving object along with the use time, the list of available moving objects may be represented by combining a plurality of moving objects selected by referring to the message and the zones.

The reservation information may include an identification number (e.g., a vehicle number) of a moving object selected by the user terminal 100 from the list, a use time, and a parking lot.

Subsequently, the server 200 may assign a moving object to the user terminal 100 based on the reservation information.

A user may directly move to the parking lot of a zone decided in the reservation information and receive the moving object, when actually using the moving object. In another example, when the user enters the zone of a fleet spot far from the parking lot for some reasons, the server 200 may move a moving object having an autonomous driving function to the standby position of the user according to the adjacent delivery request of the user terminal 100. The standby position may be confirmed based on the position information of the user terminal 100. When the moving object does not have an autonomous driving function, the server 200 may move the user to the parking lot using a separate transportation means (e.g., an unmanned shuttle operated within the fleet spot) according to the adjacent delivery request.

Hereinafter, configuration and operation of a return processing system according to an embodiment of the present disclosure are described in detail.

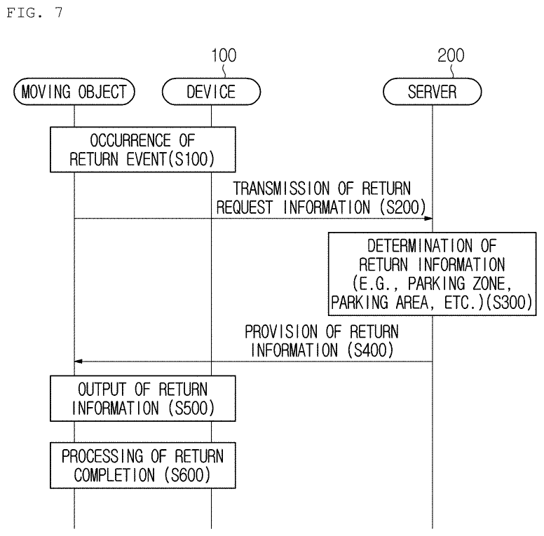

FIG. 7 is a view illustrating operation of a return processing system according to an embodiment of the present disclosure.

First, a moving object or a user terminal may determine whether a return event has occurred (S100). For example, the moving object or the user terminal may check a remaining distance (or a remaining time) to a destination at every predetermined time and trigger a return event when the remaining distance (or the remaining time) exceeds a predetermined threshold. As another example, the moving object or the user terminal may trigger the return event as a user's return request is confirmed. For example, the moving object or the user terminal may execute a program or application for a fleet system. The program or application for the fleet system may display a “return request” menu indicating the return of the moving object. In addition, as the user selects the “return request” menu, the return event may be triggered to configure return request information.

The return request information configured by the moving object or the user terminal may be transmitted to a management server through a communication network (S200). In this case, the return request information transmitted to the management server may include moving object information or device information (or user terminal information), user information, and an identifier indicating whether a return event has occurred. As another example, the return request information may include moving object information or device information, user information, and an identifier for requesting return information.

Furthermore, the user information may include information on a user who has requested use of a moving object. As another example, the user information may include information (hereinafter referred to as “passenger information”) on a user who rides in the moving object together with the user who has requested use of the moving object. To this end, the fleet system may provide an environment capable of inputting passenger information and obtain the passenger information, in a process of assigning a moving object.

On the other hand, in the fleet system, the management server may store and manage vehicle state information (e.g., mileage, tire pressure, etc.), fuel state information (e.g., the amount of remaining fuel), battery state information (e.g., remaining battery level), position information, etc. at every predetermined time. As another example, as a return event is triggered, the moving object may check vehicle state information (e.g., mileage, tire pressure, etc.), fuel state information (e.g., the amount of remaining fuel), and battery state information (e.g., remaining battery level), etc. The moving object may include vehicle state information (e.g., mileage, tire pressure, etc.), fuel state information (e.g., the amount of remaining fuel), and battery state information (e.g., remaining battery level), etc. in the return request information.

In response thereto, the management server may determine return information of the moving object in consideration of the above-described moving object information, device information, user information, vehicle state information, battery state information, fuel state information, position information, etc. (S300). In this case, the return information may include information indicating a parking zone or parking lot of a moving object. For example, the parking zone is relatively larger than the packing surface and may be a parking lot zone including a plurality of parking lots. As another example, the parking zone may be a zone within a predetermined distance range from the entrance of a parking lot. As another example, the parking zone may include an area where a moving object may temporarily stop.

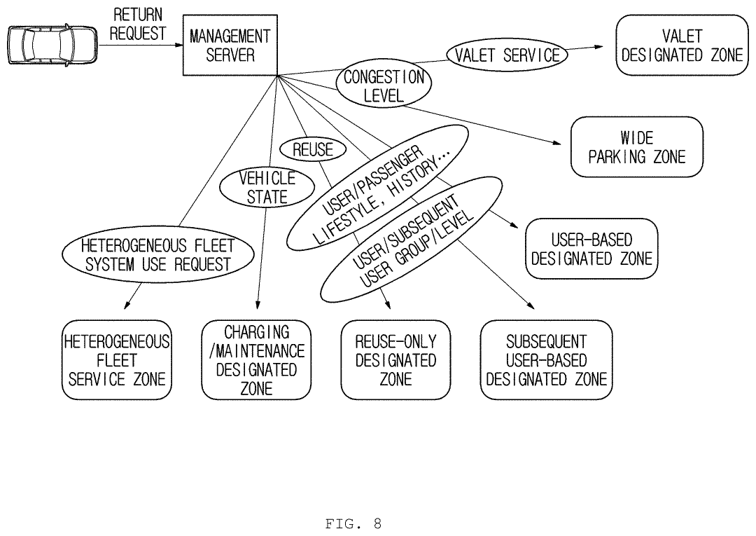

Further, the return information may be determined in consideration of various factors such as the congestion level of a parking zone, vehicle state information, battery state information, fuel state information, reuse of a user, use of a valet service, a group of users (or passengers), the usage history of a user (or a passenger) and the profile of a user (or a passenger). Detailed operation of determining the return information is described in detail below with reference to FIGS. 8-11.

Thereafter, the management server may transmit the return information of the moving object to the moving object or the user terminal, and the moving object or the user terminal may provide the return information to the user through a display, etc. (S400 and S500). Based on this, the moving object may move to a zone corresponding to the return information. The moving object may be moved by driving control of the user or may be controlled and moved by an autonomous driving function provided in the moving object.

Meanwhile, after movement of the moving object is completed, the moving object or the user terminal may process the return of the moving object (S600). For example, the moving object or the user terminal may check a parking zone and a parking lot of a zone where the moving object is parked. The moving object or the user terminal may also check whether the parking zone and parking lot of the zone where the moving object is parked are equal to a parking zone and a parking lot included in the return information. When the parking zone and the parking lot of the zone where the moving object is parked are equal to the parking zone and the parking lot included in the return information, the moving object or the user terminal may determine that the moving object is normally returned. In this case, the parking zone and the parking lot of the zone where the moving object is parked may be checked by analyzing an image captured by a camera apparatus provided in the moving object or the user terminal. As another example, the moving object or the user terminal may provide an environment capable of inputting the parking zone and the parking lot of the zone where the moving object is parked. The user may input the parking zone and the parking lot of the zone where the moving object is parked, through the provided environment.

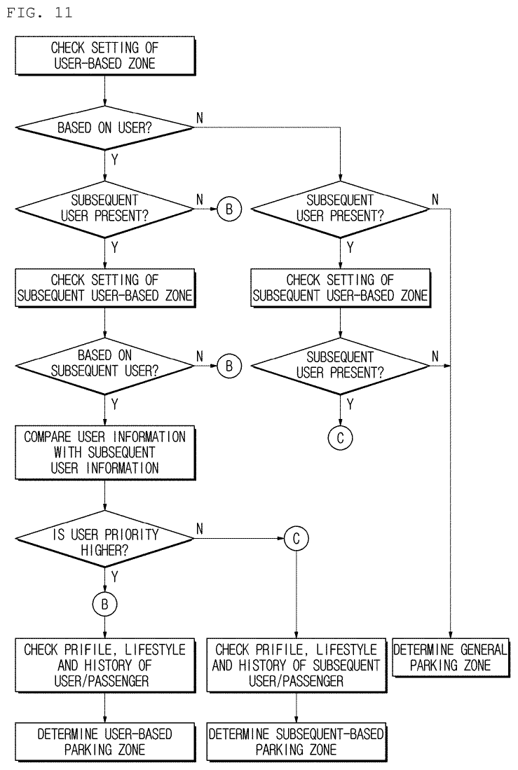

In addition, in step S600, the moving object or the user terminal may provide return completion information including whether the moving object is normally returned to the management server. In this case, the return completion information may include moving object information, user information, information indicating whether normal return is performed, and information on the parking zone and the parking lot of the zone where the moving object is parked. Furthermore, the management server may check the return completion information and, more particularly, information indicating whether normal return is performed, and update user information in consideration of whether normal return is performed. For example, when normal return is checked, the management server may mark the return history information of the user with “normal return” and add a predetermined value (e.g., “1”) to mileage related to return. Meanwhile, when abnormal return is checked, the management server may mark the return history information of the user with “abnormal return” and subtract a predetermined value (e.g., “1”) from the mileage related to return. The mileage related to return may be managed in various ways and detailed operation of managing the mileage related to return is additionally described below with reference to FIG. 12.

In step S600, the moving object or the user terminal provides the return completion information and the management server performs operation of processing return completion of the moving object based on the return completion information, but the present disclosure is not limited thereto. The moving object, the user terminal and the management server may be connected to process the return completion of the moving object. For example, the moving object or the user terminal may request the return completion processing of the moving object from the management server and the return completion of the moving object may be processed under control of the management server. In this case, the request for return completion processing may be triggered based on user input or state information of the moving object. For example, the moving object or the user terminal may execute a program or application for a fleet system and the program or application for the fleet system may display a “return completion request” menu indicating return completion of the moving object. In addition, as the user selects the “return completion request” menu, the moving object or the user terminal may trigger a return completion request event and transmit return completion request information to the management server. As another example, the moving object or the user terminal may trigger the return completion request event based on the operation state of the moving object, the locked state of the moving object, a connection state between the moving object and the device, etc. and transmit return completion request information to the management server. In this case, the return completion request may include moving object information, user information, position information, and information indicating a return completion request. Meanwhile, a return processing system may include a fleet service infrastructure apparatus such as a camera apparatus, an RFID apparatus or an NFC apparatus. In consideration of this, the management server may control the fleet service infrastructure apparatus based on the position information to check information on a parking zone and a parking lot where the moving object is parked and compare this (the parking zone and parking lot) with the return information to check whether normal return is performed.

Although the return information includes a single parking zone or parking lot in an embodiment of the present disclosure, the present disclosure is not limited thereto, and various modifications are possible. For example, the return information may include a plurality of parking zones or a plurality of parking lots. For example, the return information may include an auxiliary parking zone or an auxiliary parking lot along with a main parking zone or a main parking lot. Based on this, in step S500, the moving object or the user terminal may provide a plurality of parking zones or a plurality of parking lots and provide an environment for enabling a user to select at least one of the plurality of parking zones or the plurality of parking lots. As another example, the moving object or the user terminal may provide an auxiliary parking zone or an auxiliary parking lot along with a main parking zone or a main parking lot. In response thereto, the moving object may move to the main parking zone or the main parking lot and, if it is difficult to park the moving object in the main parking zone or the main parking lot, the moving object may move to the auxiliary parking zone or the auxiliary parking lot.

FIG. 8 is a view illustrating operation in which a management server of FIG. 7 determines return information.

First, referring to FIG. 8, factors used to determine return information may be variously configured and a parking zone may be set based on these factors.

The parking zone may include a maintenance zone, a charging zone, a valet zone, a reuse-only zone, and the like. The maintenance zone, the charging zone, the valet zone, the reuse-only zone, and the like may be physically divided zones in a fleet service zone. For example, the maintenance zone may be a zone in which maintenance of a moving object may be performed and a maintenance facility is provided. The charging zone may be a zone in which charging of a moving object may be performed and a charging facility is provided. As another example, the charging zone may be a zone in which refueling of a moving object may be performed and a refueling facility is provided and the charging zone may be replaced with a refueling zone. The valet zone may be a zone in which a valet parking service of a moving object may be performed and an infrastructure facility for the valet parking service is provided. For example, the infrastructure facility for the valet parking service may include a space in which a vehicle which uses a valet parking service may wait or a space in which a person who drives a vehicle for the valet parking service may wait. As another example, a moving object may have an autonomous driving function and the autonomous driving function may be configured to support the valet parking service. In this environment, a valet zone may be set to an entry zone of a parking facility.

Meanwhile, in an embodiment of the present disclosure, “reuse” means that a user who is currently using a moving object reuses the same moving object within a predetermined time (e.g., 30 minutes). Based on this, a reuse-only zone may be set for each parking zone. For example, at least one parking zone may be provided for each predetermined unit (e.g., every distance of 500 m) in a fleet service zone. A zone close to an entrance or exit of each parking zone may be set as a reuse-only zone.

An entity operating a fleet service (e.g., a fleet service operator) may set a predetermined zone, in which a fleet service is provided and may provide the fleet service in the set zone. In this case, the predetermined zone in which the fleet service is provided may be referred to as a fleet service zone and a fleet service zone operated by a different fleet service operator may be referred to as a heterogeneous fleet service zone. Based on the above description, the parking zone may further include a heterogeneous fleet service zone.

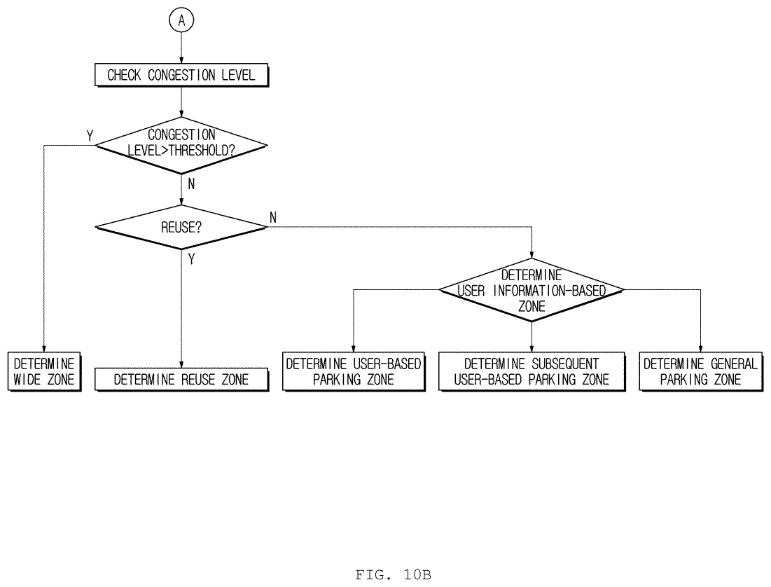

Furthermore, for efficient operation of the moving object in the fleet system, it is possible to confirm or predict a time when a current user uses a moving object and to provide a reservation function of the moving object such that a subsequent user uses the moving object after the time when the current user uses the moving object. In consideration of the above description, the management server may check user information of a user who is currently using a moving object, i.e., a current user, and set a parking zone based on this. As another example, the management server may check the user information of the above-described subsequent user and set a parking zone based on this. In this case, the parking zone set based on the user information of the current user may be referred to as a user-based designated zone. The parking zone set based on the user information of the subsequent user may be referred to as a subsequent user-based designated zone. The user-based designated zone and the subsequent user-based designated zone are set in consideration of the user information for the purpose of enhancing user convenience and thus are not physically fixed and may be variously changed according to the situation or environment. Operation of setting the user-based designated zone and the subsequent user-based designated zone is described in detail with reference to FIG. 11.

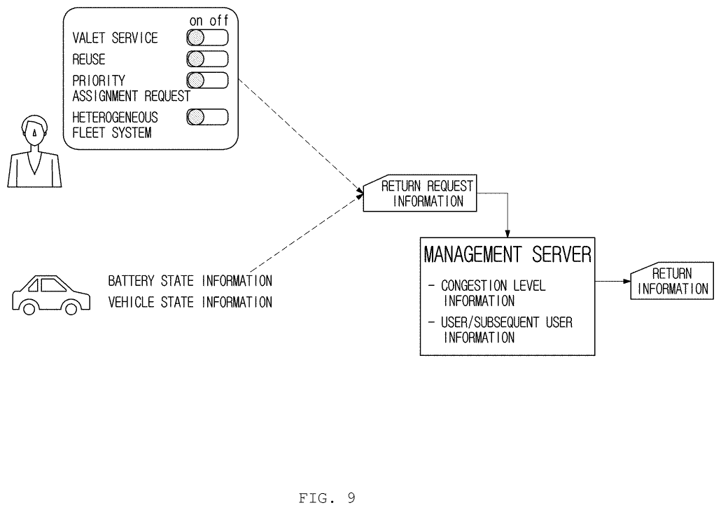

Meanwhile, as described above, the management server may consider various factors in order to set the parking zone. To this end, the fleet system may perform operation of checking the above-described factors. Hereinafter, operation in which the fleet system checks the above-described factors is described with reference to FIG. 9.

FIG. 9 is a view illustrating operation in which a return processing system according to an embodiment of the present disclosure checks factors necessary to determine return information.

Referring to FIG. 9, the fleet system may provide an environment capable of receiving the above-described factors and check the above-described factors based on information input by a user, in a process of performing assignment or return operation of a moving object. Specifically, the moving object or the user terminal may provide a menu for inputting a factor necessary for a return request as a sub-menu of a menu “return request” menu indicating the return of a moving object. In this case, the sub-menu may include a user interface capable of inputting whether to use a valet service, whether to reuse a moving object, return using a heterogeneous fleet system, and priority assignment request information. Based on this, the moving object or the user terminal may include whether to use a valet service, whether to reuse a moving object, return using a heterogeneous fleet system, and priority assignment request information in the return request information.

In addition, for example, the moving object may check battery state information including the remaining battery level or whether the battery needs to be charged and include the battery state information in the return request information. In an embodiment of the present disclosure, the moving object may be an electric vehicle driven using power provided by a battery as a power source and, based on this, battery state information is checked. Although a moving object is an electric vehicle in an embodiment of the present disclosure, the present disclosure is not limited thereto, and the moving object may include moving objects driven using various power sources. In addition, the battery state information may be replaced with the state information of a power source, which generates the power of the moving object. For example, the moving object may be driven by the power of an engine, which uses fossil fuel such as gasoline or diesel. Based on this, the state information of the power source may include information indicating the amount of remaining fossil fuel or whether to replenish fossil fuel.

In addition, for example, the moving object may check the mileage and maintenance time point of the moving object and may include maintenance state information including the mileage and maintenance time point of the moving object in the return request information. As another example, the moving object may determine whether preventive maintenance is necessary based on the mileage and maintenance time point of the moving object and include, in the return request information, maintenance state information including whether preventive maintenance is necessary. As another example, the moving object may include tire pressure, indoor cleanliness, emotional deterioration state, vehicle state, and the like of the moving object in the return request information. As another example, the moving object may digitize and manage the tire pressure, interior cleanliness, emotional deterioration state, vehicle state, and the like of the moving object, determine when maintenance is required when the checked value exceeds a predetermined threshold, and include information indicating that maintenance is required in the return request information. Herein, the emotional deterioration state represents the state of the moving object emotionally recognized through the user's sense including sight or smell.

Meanwhile, the return request information may be transmitted to the management server. The management server may check various factors included in the return request information, for example, whether to use a valet service, whether to reuse a moving object, return using a heterogeneous fleet system, battery state information, maintenance state information, vehicle state information and the like, and set a parking zone in consideration of the checked information.

In addition, the management server may check the entry or exit status of the moving object for a parking zone managed by the fleet service zone and check the congestion level of the parking zone based on the entry or exit status of the moving object. Based on this, the management server may use the congestion level of the parking zone as a factor for determining the parking zone. In other words, the management server may determine the parking zone based on the congestion level of the parking zone.

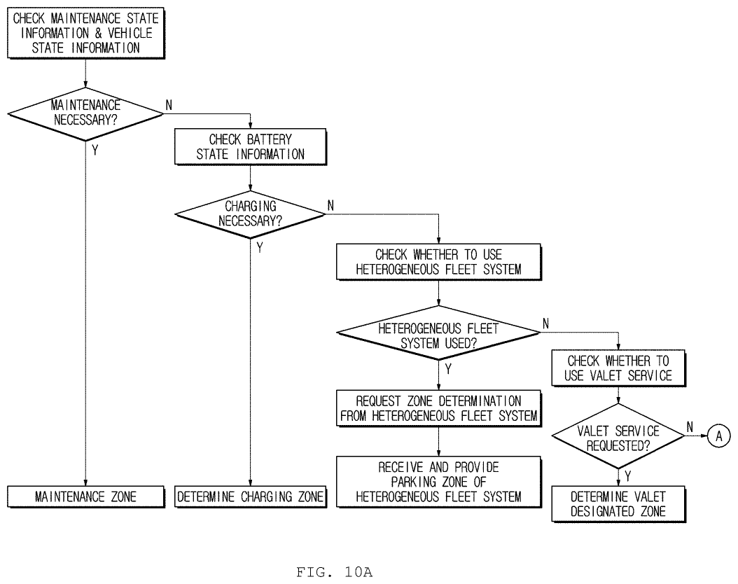

FIGS. 10A and 10B are flowcharts illustrating a detailed procedure in which the management server of FIG. 7 determines return information.

First, referring to FIG. 10A, the management server may check the state of the moving object and set a parking zone as a maintenance zone in consideration of the state of the moving object. For example, the management server may check maintenance state information and vehicle state information and set the parking zone as the maintenance zone. For example, the management server may check the mileage and maintenance time point of the moving object included in the maintenance state information and determine whether maintenance is required by checking whether the mileage and maintenance time point of the moving object exceeds predetermined criteria. As another example, the management server may check whether preventive maintenance determined by the moving object is necessary as information included in the maintenance state information and determine whether maintenance is required based on this. As another example, the management server may check tire pressure, interior cleanliness, drivability deterioration state, vehicle state, and the like of the moving object included in the vehicle state information. In addition, the management server digitizes and manages the vehicle state information including the tire pressure, interior cleanliness, emotional deterioration state, vehicle state, and the like of the moving object and determines when maintenance is required when the checked value exceeds a predetermined threshold. As another example, the management server may check information indicating whether maintenance is required in the information included in the vehicle state information and determine whether maintenance is required based on this.

Furthermore, the management server may determine a maintenance level based on the maintenance state information and the vehicle state information and set a maintenance zone suitable for the determined maintenance level. For example, the maintenance level may include light maintenance and heavy maintenance. Although a maintenance level is described in an embodiment of the present disclosure, the present disclosure is not limited thereto, and various modifications are possible.

Meanwhile, when the moving object does not request maintenance, the management server may check the battery state information and check whether charging is required. For example, the management server may check the remaining battery level or whether charging of the battery is necessary in the information included in the battery state information and determine whether battery charging is required. In addition, when the battery charging is required, the management server may set a parking zone as a charging zone.

When the moving object does not request charging, the management server may determine whether to use a heterogeneous fleet system. For example, the management server may check return using a heterogeneous fleet system in the information included in the return request information and determine whether to use the heterogeneous fleet system based on this. When use of the heterogeneous fleet system is required, the management server may provide moving object information and user information to the heterogeneous fleet system and request assignment of a parking zone or a parking lot. In addition, the management server may receive information on the parking zone or the parking lot of the heterogeneous fleet system from the heterogeneous fleet system and set this as a parking zone.

When use of the heterogeneous fleet system is not required, the management server may determine whether to use a valet service. For example, the management server may check information indicating whether to use the valet service in the information included in the return request information and determine whether to use the valet service based on this. When use of the valet service is required, the management server may set a parking zone as a valet designated zone.

Referring to FIG. 10b, when use of the valet service is not required, the management server may perform operation of checking a congestion level. For example, the management server may check a destination input by the user and check the congestion level of a parking zone close to the checked destination. Specifically, the management server may check moving objects entering and leaving a plurality of parking zones provided by the fleet service in real time and check the number of moving objects located in each parking zone based on the number of entering or leaving moving objects. Based on this, the management server may calculate the congestion level of the parking zone close to the destination. In this case, the congestion level is numerically calculated. When the congestion level has a relatively high value, this may indicate that a relatively large number of moving objects is located in the parking zone. Based on this, when the congestion level exceeds a predetermined threshold, the management server may recognize that parking in the parking zone is not smooth and set and provide a wide parking zone such that the user autonomously parks or returns the moving object.

Meanwhile, when the congestion level does not exceed the predetermined threshold, the management server may check whether reuse of the moving object is required. For example, the management server may check information indicating whether to reuse the moving object in the information included in the return request information. When the information indicates reuse of the moving object, the management server may set the parking zone as a reuse zone.

Although the management server calculates the congestion level in an embodiment of the present disclosure, the present disclosure is not limited thereto, and various modifications are possible.

When reuse of the moving object is not indicated, the management server may set a parking zone based on the user information. In this case, the user information may include information on a user who is currently using the moving object and information on a user (e.g., a subsequent user) who will use the moving object after the current user returns the moving object. Here, the information on the user may include at least one of user position information, user history information, preference information, use status information, grade information, or usage pattern information.

The management server may set a user-based parking zone or a subsequent user-based parking zone, based on information input by the current user or the subsequent user. For example, the management server may check priority assignment request information included in the return request information and, based on this, determine whether the parking zone is set based on the current user. In this case, the priority assignment request information may include information indicating whether the parking zone is set based on user information. In addition, the management server or the moving object may provide an environment in which the priority assignment request information of the subsequent user may be input in a process of requesting moving object assignment of the subsequent user and determine whether the parking zone is set based on the subsequent user. The management server may set a user-based parking zone, a subsequent user-based parking zone, or a general parking zone in consideration of the priority assignment request information of the current user or the priority assignment request information of the subsequent user. Furthermore, operation of setting the user-based parking zone, the subsequent user-based parking zone, or the general parking zone is described in detail below with reference to FIG. 11.

FIG. 11 is a flowchart illustrating a detailed procedure in which a management server of FIG. 10b determines return information based on user information.

Referring to FIG. 11, first, the management server may check the priority assignment request information included in the return request information. In this case, the priority assignment request information may be information indicating whether assignment of the parking zone is required based on the user.

When the priority assignment request information indicates setting of the parking zone based on the user, the management server may check whether there is a subsequent user of the moving object. If there is a subsequent user of the moving object, the management server may check the priority assignment request information of the subsequent user. For example, the user terminal may provide an environment in which the priority assignment request information of the subsequent user is capable of being input and provided when the subsequent user of the moving object requests assignment of the moving object. The management server may be configured to store and manage the priority assignment request information of the subsequent user. As another example, as the priority assignment request information indicates setting of the parking zone based on the user, the management server may request input of the priority assignment request information from the device of the subsequent user and receive and store the priority assignment request information input by the subsequent user. Based on this, the management server may check the priority assignment request information of the subsequent user.

As a result of checking the priority assignment request information of the subsequent user, when the information indicates setting of the parking zone based on the subsequent user, the management server may compare user information with subsequent user information. For example, the management server may classify and manage users into predetermined groups or levels while storing and managing usage history or mileage information of users who use the fleet service. Based on this, the management server may check the groups or levels of the current user and the subsequent user and compare the groups or levels of the current user and the subsequent user. In this case, the management server may check whether the group or level of the current user is set relatively higher than that of the subsequent user. When the group or level of the current user is set relatively higher than that of the subsequent user, the management server may perform operation of setting the parking zone based on the current user. Specifically, the management server may check the profile, lifestyle, and usage history of the current user (or the passenger) and set a zone capable of maximizing convenience of the current user as a parking zone based on the checked information. In contrast, when the group or level of the current user is not relatively higher than that of the subsequent user, the management server may perform operation of setting the parking zone based on the subsequent user. In other words, the management server may check the profile, lifestyle, and usage history of the subsequent user (or the passenger) and set a zone capable of maximizing convenience of the subsequent user as a parking zone based on the checked information.

Meanwhile, when there is no subsequent user in a state in which the priority assignment request information included in the return request information indicates setting of the parking zone based on the user, information on the subsequent user does not need to be considered. Similarly, when there is a subsequent user, but the priority assignment request information of the subsequent user does not indicate setting of the parking zone based on the subsequent user, information on the subsequent user does not need to be considered. In the above-described situation, the management server may perform operation of setting the parking zone based on the current user (or the passenger).

Furthermore, when there is a subsequent user in a state in which the priority assignment request information included in the return request information does not indicate setting of the parking zone based on the user, the subsequent user needs to check the priority assignment request information of the subsequent user. Therefore, the management server may perform operation of checking the priority assignment request information of the subsequent user. In the above-described situation, when the priority assignment request information of the subsequent user indicates setting of the parking zone based on the subsequent user, the management server may perform operation of setting the parking zone based on the subsequent user (or the passenger).

In contrast, when there is no subsequent user in a state in which the priority assignment request information included in the return request information does not indicate setting of the parking zone based on the user, not only information on the current user but also information on the subsequent user does not need to be considered. Similarly, when there is a subsequent user, but the priority assignment request information of the subsequent user does not indicate setting of the parking zone based on the subsequent user, information on the subsequent user does not need to be considered. Accordingly, the management server may determine the parking zone based on the destination of the current user, without considering not only the information on the current user but also information on the subsequent user.

FIG. 12 is a view illustrating user information managed by a management server provided in a fleet system according to an embodiment of the present disclosure.

Referring to FIG. 12, the management server may store and manage number-of-use information, normal return information, abnormal return information, and user level information of users who use the fleet service.

The normal return information may include information indicating the number of times of returning the moving object according to the return information (e.g., a parking zone or a parking lot) determined by the management server.

The abnormal return information may include information indicating the number of times of returning the moving object in a zone different from the return information determined by the management server.

Return mileage information may be considered in consideration of the number-of-use information, the normal return information, and the abnormal return information. For example, the management server may add mileage points according to the number of use. For example, the management server may configure an incentive point by giving a predetermined weight to the number of normal returns. In addition, for example, the management server may configure a penalty point by giving a predetermined weight to the number of abnormal returns. Further, the management server may configure return mileage information in consideration of the mileage point, the incentive point, and the penalty point according to the number of use. For example, the management server may configure the return mileage point by Equation 1 below.

return mileage point=MIᵤ+I−P [Equation 1]

(I=a*C_normal, P=b*C_abnormal)

In Equation 1, MI_u denotes a mileage point according to the number of use, I denotes an incentive point and P denotes a penalty point, a and b are predetermined weights, C_normal denotes the number of normal returns, and C_abnormal denotes the number of abnormal returns. For example, a and b may be set to 1.2 and 1.5, respectively.

Meanwhile, the user level information may indicate the grade of the user and may be set in consideration of the number-of-use information, the normal return information, the abnormal return information, and the return mileage information.

A plurality of moving objects for providing a fleet service may be present in a fleet system and a plurality of moving objects or devices may request return information approximately at the same time. In this case, approximately the same time may include the same time or a predetermined time range (e.g., 5 seconds).

Furthermore, even when a plurality of moving objects or devices does not request return information approximately at the same time, the management server may be configured to perform operation of determining return information every predetermined time (e.g., 1 minute), in order to efficiently perform operation of determining return information. When return information is determined every predetermined time (e.g., 1 minute), requested return information may be accumulated for the predetermined time (e.g., 1 minute).

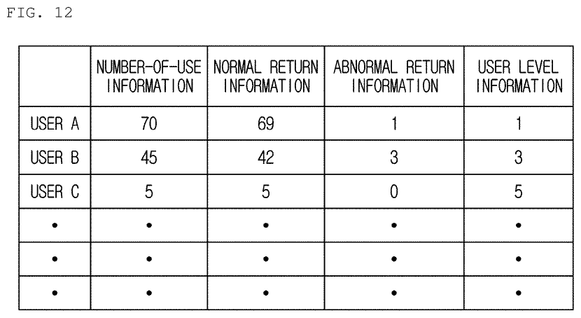

As described above, when a plurality of moving objects or devices may request return information approximately at the same time or when return information accumulated for the predetermined time (e.g., 1 minute) is processed, priority of processing of the requested return information needs to be set. Hereinafter, operation in which the management server processes return information requested by a plurality of moving objects or devices is described with reference to FIG. 13.

FIG. 13 is a view illustrating another example of operation in which a management server provided in a fleet system according to an embodiment of the present disclosure determines return information.

Referring to FIG. 13, the management server may check the return request information requested by a plurality of moving objects or devices, and check user information in information included in the return request information. In this case, the user information may include user information corresponding to a passenger riding in the moving object.

Thereafter, the management server may check grade information or group information of a user in the user information managed by the server. In this case, the user information may include user information corresponding to a passenger riding in the moving object. Furthermore, the management server may check the grade information or group information of a user or passenger riding in the moving object and detect a grade or group having a relatively highest level for each moving object. In addition, the management server may set the detected grade or group having the highest level as a grade or group of the moving object. Although the detected grade or group having the highest level is set as the grade or group of the moving object in an embodiment of the present disclosure, the present disclosure is not limited thereto, and various modifications are possible. For example, the management server may check the grade or group of the user or passenger riding in the moving object, calculate an average of the grade or group of the user or passenger riding in the moving object, and set the grade or group of the moving object. As another example, the management server may check the grade or group of the user or passenger riding in the moving object and apply a predetermined weight to the grade or group of the user or passenger riding in the moving object to set the grade or group of the moving object.

Meanwhile, the management server may align moving objects having grades or groups having relatively high levels in descending order based on the grades or groups of the plurality of moving objects. In addition, the management server may perform operation of determining the return information, in other words, the parking zone or the parking lot, of the moving object according the descending order.

Furthermore, the management server may determine the return information of the moving object by further reflecting the penalty information of the user (or the passenger). For example, the management server may set a grade or group as a main alignment criterion, align the moving objects, and then perform secondary alignment using penalty information as an auxiliary alignment criterion. As another example, the management server may set penalty information as a main alignment criterion, align moving objects, and then perform secondary alignment using a grade or group as an auxiliary alignment criterion. As another example, the management server may give a predetermined weight to penalty information and grade or group information and calculate an alignment reference value by combining the penalty information and grade or group information, to which the predetermined weight is given. In addition, the management server may perform alignment of the moving objects using the alignment reference value.

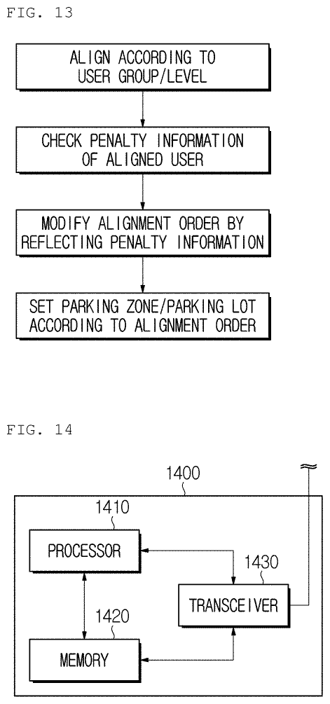

FIG. 14 is a view illustrating the configuration of an apparatus according to an embodiment of the present disclosure.

Referring to FIG. 14, the apparatus may include at least one of the above-described moving object, device, server, or RSU. In other words, the apparatus may perform communication with another device and may be linked to another device. However, the apparatus is not limited to the above-described embodiment. For example, the apparatus 1400 may include at least one of a processor 1410, a memory 1420, or a transceiver 1430 for the above-described operation. In other words, the apparatus may include components necessary to perform communication with another device. In addition, for example, the apparatus may include components other than the above-described components. In other words, the apparatus includes the above-described components to perform communication with another device, but is not limited thereto, and may operate based on the above description.

While the methods of the present disclosure described above are represented as a series of operations for clarity of description, the above is not intended to limit the order in which the steps are performed and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure. The matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A method of processing data in a fleet system, the method comprising:
determining whether a return event has occurred;
determining return information of a moving object in consideration of moving object information and user information, the return information of the moving object comprising information on a return zone of the moving object;
providing the return information to a user; and
performing return processing of the moving object based on the return information of the moving object.

2. The method of claim 1, wherein occurrence of the return event is generated based on position information of the moving object.

3. The method of claim 1, wherein the determining the return information of the moving object comprises determining the return zone of the moving object based on at least one of a congestion level of a destination, whether the moving object is reused, vehicle state information, or the user information.

4. The method of claim 3,
wherein the user information comprises at least one of group information of the user and grade information of the user, and
wherein the determining the return information of the moving object comprises determining the return zone of the moving object based on at least one of the group information of the user and the grade information of the user.

5. The method of claim 4, wherein the determining the return information of the moving object comprises:
comparing at least one of group information of the user and the grade information of the user for a current user with group information of the user and grade information of the user for a subsequent user; and
determining the return zone of the moving object based on a result of comparison.

6. The method of claim 3, wherein the user information further comprises user activity information configured based on activity time information and visiting place information of the user.

7. The method of claim 3, wherein the user information comprises information on a user who uses the moving object and information on a user who rides in the moving object.

8. The method of claim 5, wherein the determining the return information of the moving object comprises checking whether priority assignment to a subsequent user is requested.

9. The method of claim 8, wherein the checking whether priority assignment to the subsequent user is requested comprises checking whether the subsequent user is present.

10. The method of claim 9, wherein the checking whether priority assignment to the subsequent user is requested comprises whether the subsequent user has subscribed to a service for requesting the priority assignment.

11. The method of claim 1, wherein the return zone of the moving object comprises at least one of a user-based designated zone, a valet service designated zone, a reuse-only designated zone, a charging designated zone, a maintenance designated zone, a preventive designated zone, or a heterogeneous fleet service zone.

12. The method of claim 1, wherein the return information of the moving object comprises information indicating a parking lot specified in the return zone of the moving object.

13. The method of claim 1, wherein the performing return processing of the moving object comprises:
checking a return completion request of the user;
checking position information of the moving object at a point in time when the return completion request is made; and
performing return processing of the moving object based on position information of the moving object and the return information of the moving object.

14. The method of claim 13, wherein the performing return processing of the moving object comprises:
determining normal return or abnormal return in consideration of the position information of the moving object and the return information of the moving object.

15. The method of claim 14, wherein the performing return processing of the moving object comprises:
determining an abnormal return state in response to that the position information of the moving object at the point in time when the return completion request is made does not match an area set in the return information of the moving object.

16. The method of claim 4, wherein the determining the return information of the moving object comprises:
checking the grade information of the user; and
determining the return information of the moving object based on the grade information of the user.

17. The method of claim 16, wherein the determining the return information of the moving object comprises:
determining a parking lot relatively close to a destination with respect to a user whose grade information is relatively high.

18. A fleet service management server, comprising:
a transceiver configured to transmit and receive a signal; and
a processor configured to control the transceiver,
wherein the processor is configured to
check occurrence of a return event from a user terminal or a moving object,
determine return information of a moving object in consideration of moving object information, user information, and vehicle state information, the return information of the moving object comprising information on a return zone of the moving object, and
provide the return information to a user.

19. A moving object included in a fleet system to provide a fleet service, the moving object comprising:
a transceiver configured to transmit and receive a signal; and
a processor configured to control the transceiver,
wherein the processor is configured to
generate return request information based on a return event and transmit the return request information to a fleet service management server included in the fleet system,
receive return information of the moving object from the fleet service management server, the return information of the moving object comprising information on a return zone of the moving object,
provide the return information of the moving object to a user, and
perform return processing of the moving object.

20. The moving object of claim 19, wherein the processor is configured to:
check a parking zone or a parking lot of an area where the moving object is parked, and
compare the checked parking zone or parking lot with the return information of the moving object to determine normal return or abnormal return.
